(19) United States
(12) Patent Application Publication
(10) Pub. No.: US 2024/0135297 A1
(43) Pub. Date: Apr. 25, 2024

(54) SYSTEMS, METHODS AND MEDIA, FOR EVALUATING A PRODUCT, DURING ANY POINT IN ITS LIFECYCLE, BASED ON AT LEAST A DETERMINED CARBON FOOTPRINT AND/OR A DETERMINED AUTHENTICITY

(71) Applicant: FutureWELL Holdings Ltd., Saskatoon (CA)

(72) Inventors: Lee Edmondson, Delta (CA); Jason Danielson, Madge Lake (CA)

(21) Appl. No.: 18/379,577

(22) Filed: Oct. 12, 2023

Related U.S. Application Data
(60) Provisional application No. 63/416,316, filed on Oct. 14, 2022.

(51) Int. Cl. G06Q 10/0639; G06Q 50/02

(52) U.S. Cl. CPC G06Q 10/06393; G06Q 50/02

(57) ABSTRACT

Techniques are provided for evaluating a product, during any point in its lifecycle, based on at least a determined carbon footprint and/or a determined authenticity. Specifically, a carbon footprint at a field level granularity can be determined based on input characteristics of a farm, field, product, etc. Advantageously, the carbon footprint can be determined for different fields that are geographically close to each other. The determined carbon footprint may be utilized to modify one or practices at the field level. As such, the carbon footprint at the field level can be improved. Additionally, the determined carbon footprint and other relevant criteria related may be utilized to generate a customer product score that can be utilized by a consumer to make informed purchasing decisions.

### CROSS-REFERENCE TO RELATED APPLICATIONS

The present application claims the benefit of U.S. Provisional Patent Application Ser. No. 63/416,316, which was filed on Oct. 14, 2022, by Lee Edmondson et al., for SYSTEMS, METHODS AND MEDIA, FOR EVALUATING A PRODUCT, DURING ANY POINT IN ITS LIFECYCLE, BASED ON AT LEAST A DETERMINED CARBON FOOTPRINT AND/OR A DETERMINED AUTHENTICITY, which is hereby incorporated by reference.

### BRIEF DESCRIPTION OF THE DRAWINGS

The description below refers to the accompanying drawings, of which:

FIG. 1 is a high-level block diagram of an example architecture for utilizing an evaluation platform according to the one or more embodiments as described herein;

FIG. 2 is a flow diagram of a sequence of steps for determining a carbon footprint at a field level granularity according to the one or more embodiments as described herein; and

FIG. 3 a flow diagram of a sequence of steps for using customer specific information and at least one generated carbon value to identify consumer purchasing information according to the one or more embodiments as described herein.

### DETAILED DESCRIPTION OF AN ILLUSTRATIVE EMBODIMENT

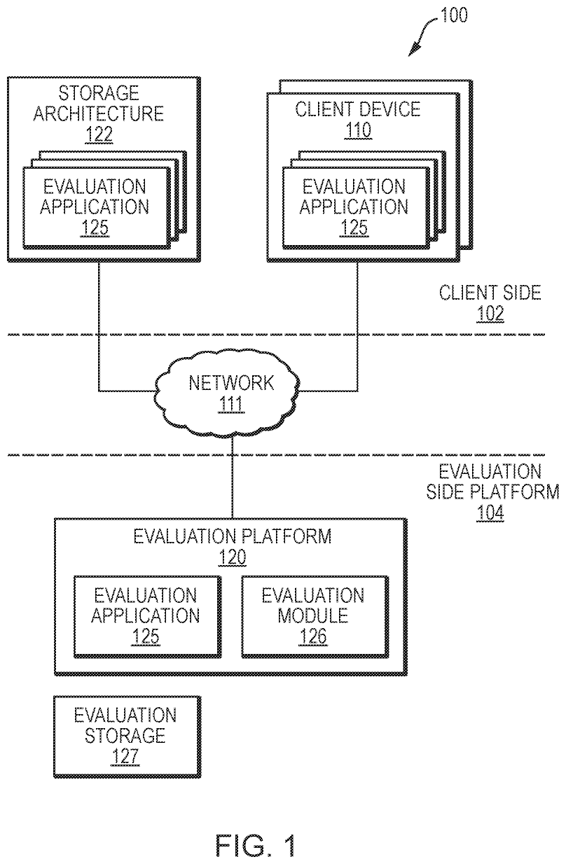

FIG. 1 is a high-level block diagram of an example architecture 100 for utilizing an evaluation platform according to the one or more embodiments as described herein. The architecture 100 may be divided into a client side 102 and an evaluation platform side 104. The client side 102 may include one or more local client devices 110 and storage architecture 122. The evaluation platform side 104 may include evaluation platform 120 that is remote from the devices of the client side 102 and that is accessible to the end users, e.g., that operate or have access to the client devices 110 and/or storage architecture 122. Each computing device, e.g., one or more local client devices 110, storage architecture 122, and evaluation platform 120 may include processors, memory/storage, a display screen, and other hardware (not shown) for executing software, storing data, and/or displaying information. In an embodiment, the evaluation platform 120 may be a cloud-based platform, e.g., one or more cloud-based devices.

A local client device 110 may provide a variety of user interfaces and non-processing intensive functions. For example, a local client device 110 may provide a user interface, e.g., a graphical user interface and/or a command line interface, for receiving user input and displaying output according to the one or more embodiments as described herein. In an embodiment, the client device 110 may be a server, a workstation, a platform, a mobile device, a network host, or any other type of computing device. The client device 110 may store evaluation application 125. In an embodiment, the evaluation applications 125 may perform one or more different functions for end users (that operate client devices 110). The evaluation application 125 may be provided by the evaluation platform 120 and installed on client device 110 such that the end user may execute evaluation application 125 to perform a variety of functions according to the one or more embodiments as described herein.

In an embodiment, an end user that operates client device 110 may be a consumer that is interested in purchasing a product, e.g., an ingredient or food item, from a merchant. In an embodiment, the end user that operates client device 110 may be a custodian or any of a variety of different individuals or entities that assist in the production, storage, processing, or sale of the product at a point in time during the life cycle of the product. Although the examples described herein may refer to an ingredient or food item, it is expressly contemplated that the one or more embodiments as described herein may be applied to any product or service. As such, the examples herein that refer to an ingredient or food (e.g., blueberry, shrimp, etc.) are for illustrative purposes only.

The end user may utilize the evaluation application 125 such that one or more functions are implemented according to the one or more embodiments as described herein. The results of the one or more implemented functions may be provided to the user by way of the client device 110 and utilized by the user to make, for example, informed purchasing decisions according to the one or more embodiments as described herein.

For example, such functions that may be implemented by the evaluation platform 120 may include, but are not limited to, authenticating an integrity of a product (e.g., ingredient or food product) being purchased from a merchant by the consumer, determining the carbon footprint for a product at a point in time during the lifecycle of the product, generating a score for a product that considers a variety of factors (e.g., carbon footprint, authenticity, practices implemented at manufacturer of product, etc.) based on criteria that is valued or important to the consumer. Such functions may be described in further detail below. The results of the implemented functions may be displayed on, for example, the client device 110 and the consumer may utilize the results to make informed purchasing decisions as will be described in further detail below.

In an embodiment, an end user that operates client device 110 may be a manufacturer of a product or an entity that participates in the production, cultivation, transportation, storage, and/or participates in some point between the production of the product (e.g., ingredient harvested at a farm) to when the product is offered for sale (e.g., the product is placed on a shelf at a store for purchase by consumers). For example, the entity may be a farmer. Although the examples described herein may refer to a farmer, it is expressly contemplated that the one or more embodiments as described herein may apply to any entity that is associated with a product or service.

The entity may utilize the evaluation application 125 such that one or more functions are implemented according to the one or more embodiments as described herein. The results of the one or more implemented functions may be provided to the entity by way of the client device 110 and utilized by the entity to make one or more decisions. For example, and as described in further detail below, the functions implemented by the evaluation platform 120 may include evaluating one or more characteristics associated with a product that are related to carbon sequestration and/or one or more characteristics associated with the product that are related to carbon emission. The evaluation platform may analyze the characteristics utilizing one or more different algorithms of a carbon calculator to calculate a carbon value that indicates if and to what degree the farm producing the product is, for example, carbon positive (climate negative), carbon neutral, or carbon negative (climate positive). In an embodiment, the carbon value may be referred to as a “carbon footprint”, and the carbon value and carbon footprint may be used interchangeably according to the one or more embodiments as described herein.

Based on the calculated carbon value, the evaluation platform 120 may, for example, evaluate the entity's implemented practices to determine one or more changes that may be implemented by the entity to improve the environmental footprint of the entity such that the carbon value changes for the entity to be more carbon negative (climate positive). The carbon value and determined changes may, for example, be displayed on the client device 110 and the entity may understand the way the entity's practices may be modified to improve its environment footprint, which may result in increased revenue for the entity.

The storage architecture 122 on client side 102 can be any of a variety of different types of storage architectures or systems that receives and/or sends, over network 111, information to/from the evaluation platform 120 and/or client device 110. The storage architecture 122 may include, but is not limited to, cloud storage, databases, applications, application program interfaces (APIs), the Internet of Things (IoT) storage, hard disk drives, solid state drives, etc. In an embodiment, the storage architecture 122 may store/host evaluation application 125 such that client device 110 may access and execute the evaluation application 125 to, for example, implement the different functions as described herein.

The evaluation platform 120 may store and execute evaluation module 126 that may implement the one or more embodiments as described herein. For example, the evaluation module 126 may implement the carbon calculator according to the one or more embodiments as described herein. For example, the evaluation module 126 may determine the carbon footprint based on an analysis of the carbon sequestered and the carbon emitted during the like cycle of the product, e.g., from production to being provided to a merchant for sale. In addition or alternatively, the evaluation module 126 may generate a score based on factors that are important to a consumer such that the consumer can make an informed purchasing decision as described herein.

Additionally, client device 110 may access and execute the evaluation application 125 on evaluation platform 120 to, for example, implement the one or more functions as described herein.

The evaluation platform 120 may be coupled to evaluation storage 127. Evaluation storage 127 may be cloud storage, one or more databases, one or more hard disk drives (HDDs), one or more solid state drives (SSDs), etc. In an embodiment, the evaluation storage 127 may store one or more values, data structures, models, etc. that are generated and/or utilized according to the one or more embodiments as described herein.

It will be apparent to those skilled in the art that other types of processing elements and memory, including various computer-readable media, may be used to store and execute program instructions pertaining to the embodiments as described herein.

Also, while the embodiments herein are described in terms of software code, processes, and computer programs (e.g., applications) stored in memory, alternative embodiments also include the code, processes and programs being embodied as logic, components, modules and/or engines consisting of hardware, software, firmware, or combinations thereof.

### Illustrative Product Journey In an Environment to Obtain Environmental Footprint

An entity that produces a product in an environment may utilize the evaluation platform 102 according to the one or more embodiments as described herein to determine an environmental, e.g., carbon, footprint for the entity's environment. In an embodiment, an entity may be any individual (e.g., farmer), corporation, affiliate, etc. that may have control or ownership of the environment where the product is produced, processed, and/or stored during the product's lifecycle. In an embodiment, a product's lifecycle may start at the product's inception (e.g., when an ingredient is planted in soil), through the product being processed at one or more different sites, through the sale of the product at a store to a consumer. In an embodiment, the product may be an ingredient (e.g., blueberries), an item of food (e.g., shrimp, fish, meat, etc.), and/or any other type of product. In an embodiment, the environment may be any location that manufacturers, processes, and/or stores the product during its lifecycle.

As an example, and as will be described in further detail below, a farmer (entity) may utilize the evaluation platform 120 to determine a carbon value, e.g., carbon footprint, for different fields of the farmer's farm (environment). The carbon value may indicate if and to what degree the farm is carbon negative, carbon neutral, or carbon positive. The farmer may then implement one or more changes, suggested by the evaluation platform 120, to modify the environmental footprint of the farm. By generating and providing the suggestions that can be implemented to improve a carbon footprint, the one or more embodiment as described herein are integrated into a practical application, as will be described in further detail below. Additionally, and as will be described in further detail below, the evaluation module 126 may implement one or more different algorithms that consider farm, product, and/or field characteristics to determine the carbon footprint at a field specific level, for example. Further, and as will be described in further detail below, the evaluation module 126 may generate a carbon ledger that determines the carbon footprint of the product as it moves along each stage of its lifecycle.

Although the examples as described herein may at times refer to a farm, farmer, blueberries, and/or shrimps, it is expressly contemplated that the one or more embodiments as described herein may be applicable to any environment in which a product is manufactured, processed, and/or stored. For example, the one or more embodiments as described herein may be applicable to an environment where cattle is raised and that results in the production of meat that is sold at a grocery store. Additionally, the one or more embodiments as described herein may be applicable to an environment where fish is stored after procurement, wherein the fish is eventually sold at a market. Moreover, the one or more embodiments as described herein may be applicable to a laboratory where a plant is grown and then eventually sold to a restaurant or at a grocery store. As such, it should be understood that the examples as described herein are for illustrative purposes only, and the one or more embodiments as described herein are applicable to any environment associated with the manufacturing, processing, and/or storage of a product.

In an embodiment, a user (e.g., farmer) affiliated with an environment (e.g., farm) may register with the evaluation platform 120 to create a unique account. For example, the user may utilize client device 110 to provide specific information to register the environment with the evaluation platform 120 in a conventional manner. Based on the registration, the environment may be assigned credentials, e.g., a unique username and password, such that any user affiliated with the environment can access the unique account using the credentials and then implement one or more functions provided by the evaluation platform 120.

After establishment of the unique account, the evaluation platform 120 may provide one or more interfaces (e.g., graphical user interfaces and/or command line interfaces) that may be provided on a display screen on client device 110 that is being utilized by the user. The user may utilize the one or more interfaces to provide information to the evaluation platform 120. In an embodiment, the information may include one or more characteristics associated with the environment (e.g., farm, field of the farm, body of water, laboratory, transportation vehicles) where the product is produced, processed, and/or stored. In addition or alternatively, the information may include characteristics of the product itself, characteristics regarding practices and/or techniques utilized in the environment to produce, process, and/or store the product, etc.

In an embodiment, the characteristics may affect the carbon emission and/or carbon sequestration in the environment as will be described in further detail below.

The following two examples describe the operation of the carbon calculator in relation to blueberries and shrimps. The two examples are for illustrative purposes only, and the examples as described herein are not intended to limit the scope of the disclosure. As such, it is expressly contemplated that the carbon calculator may operate, in a similar manner as described in the examples, to determine the carbon footprint for any of a variety of different environments that produce, process, and/or store a product.

### Illustrative Example for Operation of Carbon Calculator for Blueberries

In this example, the carbon calculator may be utilized to calculate both carbon sequestration value and carbon emission value for a blueberry farm at a particular geographical location (e.g., longitude and latitude). Based on the calculation of carbon sequestration value and carbon emission value at the blueberry farm, the carbon calculator may determine the overall carbon footprint of the farm or different fields of the same farm. In an embodiment, the carbon footprint may indicate the degree to which the blueberry farm or fields of the blueberry farm is carbon negative, carbon neutral, or carbon positive. By determining the carbon footprint in the manner described herein, the one or more embodiments can accurately and precisely determine the carbon footprint of a product at any point in its lifecycle and at a more granular level reflective of individual fields or sub-divisions of a larger farm or operation. By accurately and precisely determining the carbon footprint of a product at any point in its lifecycle that can be provided to a user, the one or more embodiments as described herein are integrated into a practical application.

In this example, let it be assumed that Lee owns and operates Lee's Farm that produces blueberries. Further, let it be assumed that Lee has established a unique account with evaluation platform 120 in a manner as described above. As such, Lee and/or other affiliates of Lee's Farm may access and utilize the carbon calculator according to the one or more embodiments as described herein. During the establishment of the unique account with the evaluation platform 120 or after establishing the unique account with the evaluation platform 120, Lee may utilize client device 110 to provide, i.e., input, a variety of different information that describes the attributes associated with Lee's Farm, the attributes associated with different fields of Lee's Farm, and/or the attributes associated with blueberries produced at Lee's Farm. As will be described in further detail below, the evaluation module 126 of the evaluation platform 120 may utilize the provided information to determine the carbon footprint of Lee's Farm. In fact, and as will be described in further detail below, the evaluation module 126 may utilize the provided information to determine different carbon footprints for two different fields of Lee's Farm.

### Farm Characteristics

In an embodiment, Lee may utilize one or more user interfaces, that are provided by evaluation platform 120 for display on client device 110, to provide characteristic information associated with Lee's Farm. Specifically, Lee may utilize the user interfaces to provide a name or identifier for Lee's Farm. The name/identifier may be utilized to differentiate Lee's Farm that produces blueberries from other farms owned/operated by

Lee. For example, if Lee also operates an apple farm, Lee's apple farm would have an associated identifier. As such, Lee can select each of the farms, utilizing the associated identifiers, such that the functionalities of the platform 120 can be implemented with the selected farm, e.g., environment. Additionally, Lee may utilize the user interfaces to provide a location (e.g., city, province/state, country, postal code, etc.) of Lee's Farm. In this example, let it be assumed that Lee utilizes the user interface to indicate that the name of his farm is “Lee's BB farm” and that the farm is located at 3 Treetop Lane in Livermore, California, 94550.

The evaluation module 126 may execute one or more application program interfaces (APIs) to determine a geographical location, e.g., longitude and latitude, of Lee's Farm based on the provided location information. Additionally, the evaluation module 126 may utilize the location information and/or determined geographical location to obtain climate condition information that is applicable to Lee's Farm. Specifically, the evaluation module 126 may query one or more external sources utilizing the location information and/or the determined geographical location to identify and/or determine climate condition information related to Lee's Farm. Such climate information may include, but is not limited to, temperatures at Lee's Farm at different dates/times, rainfall at Lee's Farm at different dates/times, air quality data at Lee's Farm at different dates/times, other precipitation information, wind information at Lee's Farm at different dates/times, etc.

As will be described in further detail below, the evaluation module 126 may utilize the determined climate information and/or other provided information to calculate or determine a carbon sequestration value and/or a carbon emission value for Lee's Farm.

In an embodiment, and as will be described in further detail below, the evaluation module 126 may map the determined climate information against a soil organic carbon (SOC) reference value by geo-climate zoning to calculate one or more carbon sequestration values for Lee's Farm that is attributed to the climate.

In addition or alternatively, Lee may utilize the one or more provided user interfaces to provide information related to any of a variety of different types of farm management software that are utilized at Lee's Farm. For example, the farm management software may include, but is not limited to, farming practices, fertilizers used, type and amount of irrigation, type of disease management, amount of fuel used by machinery, etc.

If Lee's Farm utilizes farm management software, the evaluation module 126 may access data from the farm management software that may be utilized to more accurately determine a carbon sequestration value for Lee's Farm. Such data may include, but is not limited to, farming practices, type and amount of fertilizers, pesticides, and/or other chemicals used, type and amount of irrigation, type of disease management, amount and type of fuel used by machinery, etc.

Alternatively, the farm management data may be obtained via user input. As such, a variety of different information related to Lee's Farm may be utilized by the evaluation module 126 to determine or calculate a carbon sequestration value and/or carbon emission value for Lee's Farm, which will be described in further detail below. In an embodiment, as more robust information from different sources is utilized to determine carbon sequestration values and/or carbon emission values according to the one or more embodiments as described herein, the accuracies of the values improve.

### Field Specific Characteristics

According to the one or more embodiments as described herein, the evaluation module 126 may utilize field specific information to determine a different carbon footprint for different fields of a same farm.

For this example, let it be assumed that Lee's Farm includes at least two different fields, e.g., field A and field B, that are utilized to produce blueberries. Further, and in this example, let it be assumed that Lee utilizes different protocols to produce the blueberries in field A and field B. In an embodiment, a protocol may be referred to as a management practice and may comprise practices that include, but are not limited to, tillage, crop rotation, residue management, fertilizer used, pesticides used, etc. In an embodiment, the management practices utilized at each of field A and field B of Lee's Farm may be provided, i.e., input, to the evaluation platform 120 utilizing one or more user interfaces provided to client device 120.

Different management practices may be utilized at different fields of the same farm for a variety of different reasons. For example, different management practices may be utilized at different fields to determine which management practices are best to harvest blueberries at Lee's Farm. In addition or alternatively, different management practices may be utilized based on different conditions in the two fields. For example, if field A is exposed to more sunlight than field B, particular management practices that are beneficial for high sun exposure areas may be utilized at field A, while other management practices that are beneficial for areas will less sun exposure may be utilized at field B. As such, it is expressly contemplated that the same or different management practices can be implemented at different fields of a same farm according to the one or more embodiments as described herein.

Therefore, the carbon footprints determined according to the one or more embodiments as described herein can have a granularity that is field level specific. This is in contrast to some conventional systems that can only determine a single carbon footprint for a plurality of different fields that are within the same general location. As an example, consider the location of the country of Mexico. Let it be assumed there are hundreds of different types of farms that are located in Mexico. With some conventional systems, only a single or few carbon footprints can be determined for all of the farms in Mexico based on the utilization of general or high-level information (e.g., aggregated data available for the country of Mexico). In contrast, the one or more embodiments as described herein can not only determine a different carbon footprint for each of the different farms located in Mexico, the one or more embodiments as described herein provide the robustness and granularity to even determine different carbon footprints for different fields of the same farm. Specifically, and as will be described in further detail below, the one or more embodiments as described herein can utilize field specific data to determine a carbon footprint that is field specific.

As such, the one or more embodiments as described herein provide an improvement in the existing technological field of carbon capture technology. By determining the carbon footprint at the field level, entities that produce products can better understand their true carbon footprint and the effect of their farm on the environment. This in turn allows entities with the ability to better implement practices to improve the environmental footprint for the field or fields in which the product is produced, processed, and/or stored.

As such, the one or more embodiments as described herein provide an improvement in the field of electronic Green House Gas (GHG) measurement/management technology and/or electronic carbon measurement/management technology . In addition, this information is then made available to the consumer who can make a choice on the best quality food products based on the best carbon score for that specific food group at that specific farm as opposed to aggregate country wide or region wide data.

By generating the carbon footprint at a field level granularity instead of at a farm level as is done with some conventional systems, the one or more embodiments as described herein are integrated into a practical application. That is, a carbon calculator that can determine a carbon footprint at the field level is a practical application in emerging and developing technologies of carbon capture technology, electronic GHG measurement/management technology, and/or electronic carbon measurement/management technology. In addition to utilizing management practices to determine a carbon footprint, the one or more embodiments as described herein may also utilize the physical attributes of the field to determine the carbon footprint. For example, the physical attributes may include, but are not limited to, size of the field, usage (e.g., crops, fruit), soil color, soil texture, number of tree/plants per acre, year of plantation (for tree-based crops only), land type, etc. In an embodiment, the physical attributes of the field may be provided, i.e., inputted, to the evaluation platform 120 utilizing one or more interfaces displayed on client device 110. As such, and in this example, physical attributes of field A and field B may be provided to evaluation platform 120.

### Product Characteristics

The user may also provide product specific characteristics that can be utilized to determine the carbon footprint. In this example, Lee may utilize the one or more user interfaces, provided via client device 120, to indicate that the product is blueberries. In addition, Lee may utilize the one or more user interfaces to indicate the yield quantity of the blueberries produced at field A and field B of Lee's Farm. Further, a start date and an end date for which the evaluation module 126 is implementing the carbon calculator for Lee's Farm may also be provided by Lee via the user interfaces. For example, the yield quantity may be the amount of blueberries produced over the time period (e.g., between the start date and end date) at field A and field B of Lee's Farm in terms of metric ton (MT).

Although in the example above the characteristic information may be provided via user interfaces, it is expressly contemplated that such characteristic information may be obtained by the evaluation module 126 in any of a variety of different ways. For example, the evaluation module 126 may query one or more storage devices or external sources that store the characteristic information. As such, it should be understood that the one or more embodiments as described herein are applicable to determining a carbon footprint utilizing characteristic information regardless of the manner in which said characteristic information is obtained.

Calculating Carbon Emission Data (e.g., Value) at the Field Level Utilizing Received or Obtained Characteristic information

In an embodiment, the management practice of using a fertilizer in a field may be considered when calculating a carbon emission value for the field.

Continuing with the example of Lee's Farm that produces blueberries, let it be assumed that field A utilizes a fertilizer without Urea and field B utilizes a fertilizer with Urea. According to the one or more embodiments as described herein, the evaluation module 126 may calculate or determine a carbon emission value that indicates the impact that the fertilizer has on the carbon emission produced at the field. In addition or alternatively, the evaluation module 126 may recommend (e.g., display) a different fertilizer based on the determined carbon emission value corresponding to a currently used fertilizer.

In this example, field A utilizes fertilizer other than Urea. As such, the evaluation module 126 may determine the carbon emissions that are attributed to the fertilizer based on the nitrogen (N) component in the fertilizer used. Specifically, the evaluation module 126 may multiply the N component with a predetermined emission factor. In an embodiment, the predetermined emission factor may be obtained from a public and/or external source. For example, the external source may be the United States (US) Environmental Protection Agency (EPA). After the N component is multiplied by the predetermined emission factor, the result may be converted into a CO₂ equivalent that represent the carbon emission that is attributed to the fertilizer. In an embodiment, the conversion into a CO₂ equivalent is obtained using a conversion formula that is based on the ratio of nitrous oxide (N₂O) to nitrite nitrogen (N₂O—N) of the fertilizer and the global warming potential (GWP) of the fertilizer. For example, the CO₂ for the fertilizer without Urea may be calculated as:

Emissions (MMTCO₂E)=Total N×fraction volatilized (0.1 synthetic or 0.2 organic)×0.001 (kg N₂O—N/kg N)×44/28 (Ratio of N₂O to N ₂O—N)×298 (GWP)÷1,000,000,000 (kg/MMTCO₂E)

where Emissions (MMTCO₂E) is the nitrogen component of the carbon emission attributed to the fertilizer without Urea. Total N is the N component for the fertilizer without Urea. The fraction volatized is 0.1 if the fertilizer without Urea is synthetic and the fraction volatized is 0.2 if the fertilizer without Urea is organic.

In this example, let it be assumed that 1000 kg (1 metric ton) of an organic fertilizer without Urea is used in field A, and the N component is a value of 100%. Accordingly, the nitrogen component for the carbon emission attributed to the fertilizer in field A is a value of 4.67 tCO2e based on the formula above. As such, 4.67 tCO2e that is calculated based on the formula above quantifies the effect/impact the fertilizer without Urea has on the carbon emission produced at field A of Lee's Farm.

Continuing with the example, 1000 kg (1 metric ton) of Urea fertilizer is utilized in field B. Since Urea is utilized, the carbon component for the carbon emission attributed to the fertilizer is considered in addition to the nitrogen component which is considered in the example above. The carbon component may be calculated as:

Emissions (MMTCO₂E)=Total Urea Applied to Soil (metric tons)×Emission Factor (tons C/ton urea)×44/12 (ratio of CO₂ to C)÷1,000,000 (to yield MMTCO₂E)

In this example, let it be assumed that the total Urea applied to the soil of field B is 1000 kg (1 metric). As such, the carbon component of the carbon emission attributed to the fertilizer with Urea that is utilized in field B is 0.073 tCO2e. Further, in this example, let it be assumed that the nitrogen component for the fertilizer utilized in field B is 2.154 tCO2e. Therefore, the carbon emission attributed to the Urea fertilizer utilized in field B is a summation of the nitrogen component and the carbon component. As such, and in this example, the carbon emission attributed to the fertilizer used in field B is 2.23 tCO2e (e.g., 0.073+2.154). Therefore, 2.23 tCO2e that is calculated based on the two formulas above quantifies the effect/impact the fertilizer with Urea has on the carbon emission produced at field B of Lee's Farm.

In addition to considering fertilizer to determine the carbon emission for the field, the one or more embodiments as described herein may also consider the pesticides utilized in the field. For example, such pesticides may include, but are not limited to herbicide, insecticide, nematicide, molluscicide, piscicide, avicide, rodenticide, bactericide, insect repellent, animal repellent, microbicide, fungicide, lampricide, etc. In an embodiment, evaluation module 126 may utilize the total quantity of the pesticide utilized in the field with the predetermined emission factor, as described above, to calculate the CO₂ equivalent for each of the pesticides used. In an embodiment, the total quantity used may be indicated in a unit of Kg or liter.

For this example, let it be assumed that three pesticides are utilized in field A of Lee's Farm. As such, the amount of each pesticide utilized in field A will be multiplied by the predetermined emission factor and the three results may be summed together to calculate the carbon emission attributed to the use of the three pesticides in field A. For this example, let it be assumed that the carbon emission attributed to the use of the three pesticides in field A is equal to 0.022 tCO2e for 1 kg of pesticides used . Further, let it be assumed that a single pesticide is utilized in field B. As such, the amount of the single pesticide utilized in field B will be multiplied by the predetermined emission factor to calculate the carbon emission attributed to the use of pesticides in field B. For this example, let it be assumed that the carbon emission attributed to the use of the single pesticide in field B is equal to 0.11 tCO2e for 5 kg of pesticides used.

In addition to considering fertilizer and pesticides to determine the carbon emission for the field, the one or more embodiments as described herein may also consider residual management utilized in the field. For example, Lee may utilize the one or more user interfaces to provide, i.e., input, residual management information to the evaluation platform 120. The residual management information may include, but is not limited to, reusage of residue, burning, and percentage of burning. The residual information may, for example, be utilized with particular crop management information to determine the impact on carbon emissions in the field. If, for example, user utilizes green manure (i.e., reuse residue) in a field, the following formula may be utilized:

Emissions (MMTCO₂E)=Crop Production (MT)×Mass ratio (residue/crop)×Dry Matter Fraction ×Fraction Residue Applied ×N content×Emission Factor (1.0%)×44/28 (Ratio of N₂O to N ₂O—N)×298 (GWP)÷1,000,000,000 (kg/MMTCO₂E)

where Emissions (MMTCO₂E) is the nitrogen component of the carbon emission attributed to the reusage of residue, crop production is the yield quantity, mass ratio (residue/crop) may be obtained for a particular crop from Crop Residual Table A below. Dry matter fraction, fraction residual applied, and the N component content for a crop may be obtained from Crop Residual Table B blow.

Crop Residual Table A

| | Residue:Crop |
|---|---|
| Crop | Mass Ratio |
| Alfalfa | 0 |
| Corn of Grain | 1.0 |
| All Wheat | 1.3 |
| Barley | 1.2 |
| Sorghum | 1.4 |
| Oats | 1.3 |
| Rye | 1.6 |
| Millet | 1.4 |
| Rice | 1.4 |
| Soybeans | 2.1 |
| Peanuts | 1.0 |
| Dry Edible Beans | 2.1 |
| Dry Edible Peas | 1.5 |
| Austrian Winter peas | 1.5 |
| Lentils | 2.1 |
| Wrinkled Seed peas | 1.5 |
| Sugarcane | 0.2 |
| Pulses | 1.37 |
| Triticale | 1.5 |
| Canola/Oilseeds | 2.08 |

Crop Residual Table B

| | Residue | | | |
|---|---|---|---|---|
| | DRY | Fraction | | |
| | matter | Residue | N content | C content of |
| CROP | fraction | applied | of Residue | Residue |
| Alfalfa | 0.85 | 0.00 | NA | |
| Corn for Grain | 0.91 | 0.90 | 0.0058 | 0.4478 |
| Barley | 0.93 | 0.90 | 0.0077 | 0.4485 |
| Sorghum | 0.91 | 0.90 | 0.0108 | |
| Oats | 0.92 | 0.90 | 0.0070 | |
| Rye | 0.90 | 0.90 | 0.0048 | |
| Millet | 0.89 | 0.89 | 0.0070 | |
| Rice | 0.91 | 1.00 | 0.0072 | 0.3806 |
| Soybeans | 0.87 | 0.90 | 0.0230 | 0.4500 |
| Peanuts | 0.86 | 0.90 | 0.0106 | 0.4500 |
| Dry Edible Beans | 0.87 | 1.55 | 0.0168 | |
| Dry Edible Peas | 0.87 | 0.90 | 0.0168 | |
| Lentils | 0.85 | 1.55 | 0.0168 | |
| Wrinkled Seed Peas | 0.87 | 0.90 | 0.0168 | |
| Sugarcane | | | | 0.42 |
| Pulses | 0.87 | | 0.0090 | 0.40 |
| Triticale | 0.88 | | 0.0060 | 0.40 |
| Wheat | 0.93 | 0.90 | 0.0062 | 0.44 |
| Canola/Oilseeds | 0.96 | | 0.0090 | 0.44 |

Let it be assumed that 1 ton of blueberries is produced at each of Field A and B. Based on the formula above and selected values (e.g., in this example, let it be assumed that the largest values are selected from the tables for the blueberries) from Tables A and B for field A and field B of Lee's Farm, let it be assumed that (1) the carbon emission attributed to the reusage of residue in field A of Lee's Farm is 0.177 tCO2e, and (2) the carbon emission attributed to the reusage in field B of Lee's Farm is 0.177 tCO2e.

The evaluation module 126 may sum the individual carbon emission values determined for a field to determine a total carbon emission value for the field. Therefore, and in this example, the evaluation module 126 determines that the total carbon emission value for field A of Lee's Farm is 4.869 tCO2e (e.g., 4.67 tCO2e+0.022 tCO2e+0.177 tCO2e). Specifically, the total carbon emission value is a sum of (1) the carbon value determined for the fertilizer used in field A, (2) the carbon values determined for the pesticides used in field A, and (3) the carbon value determined for the reuse of residue used in field A. The evaluation module 126 may determine, in a similar manner, that the total carbon emission value for field B of Lee's Farm is 2.517 (e.g., 2.23 tCO2e+0.11 tCO2e+0.177 tCO2e).

Therefore, and in this example, a different carbon emission value can be calculated for field A and field B of Lee's Farm based on the specific characteristics of each field. Although the examples as described herein for Lee's Farm determine the carbon emission values for a field based on the fertilizer, pesticides, and reuse of residue, it is expressly contemplated that fewer or additional farm/product/field characteristics may be utilized to determine the carbon emission value for a field according to the one or more embodiments as described herein. For example, in addition to considering fertilizer, pesticides, and reuse of residue, the evaluation module 126 may also consider lime and dolomite usage used in the field and/or the type and amount of energy used in the field. As such, the examples as described herein are for illustrative purposes only, and it should be expressly understood than any of a variety of different farm/product/field characteristics may be utilized to determine the carbon emission value according to the one or more embodiments as described herein.

Calculating Carbon Sequestration Data (e.g., Value) at the Field Level Utilizing Received or Obtained Characteristic information

In addition to calculating the carbon emission value for a field in the manner described above, the evaluation module 126 may also calculate a carbon sequestration value for a field utilizing farm/product/field characteristics. For example, farming type (conventional, conservational, hybrid), tillage practices, and crop management practices (crop rotation, cover cropping, N fixing crops, etc.) utilized in a field can have significant impact on the amount of carbon sequestered in a field.

In an embodiment, the evaluation module 126 may determine an annual change in organic carbon stock in mineral soils of the field to determine the impact of the above described characteristics on the carbon sequestration of the field. In an embodiment, an annual change in organic carbon stock in mineral soils (ΔC_{Mineral}) may be calculated using the Intergovernmental Panel on Climate Change (IPCC) Tier 3 approach as:

$$ANNUAL CHANGE IN ORGANIC CARBON STOCKS IN MINERAL SOILS$$

$$Δ {C}_{Mineral} = \frac{( {SOC}_{0} - {SOC}_{( 0 - T )} )}{D} \\ SOC = {\sum }_{c , s , i} ( {SOC}_{{REF}_{c , s , i}} \cdot {F}_{{LU}_{c , s , i}} \cdot {F}_{{MG}_{c , s , i}} \cdot {F}_{{I}_{c , s , i}} \cdot {A}_{c , s , i} )$$

where A may be the area of the field, and where SOC_{REF} may represent a soil organic carbon reference value for the field based on the climate region of the field and soil type of the field. For the example of Lee's Farm, the SOC_{REF} value will be based on the climate region in Livermore, California and the type of soil that are respectively utilized in field A and field B. Further, SOC₁₀ may represent the SOC of the field at the year of the start of cultivation, while SOC_{T} may represent the SOC of the field at the year of the assessment. In an embodiment, D is an integer value in years. For example, the default value for D may be 20. In an embodiment, the SOC_{REF} value may be obtained from the IPCC table below:

DEFAULT REFERENCE (UNDER NATIVE VEGETATION)
SOIL ORGANIC C STOCKS (SOC_{REF}) FOR MINERAL SOILS
(TONNES C HA⁻¹ EN 0-30 CM DEPTH)

| | HAC | LAC | Sandy | Spodic | Volcanic | Wedland |
|---|---|---|---|---|---|---|
| Climate region | soils¹ | soils² | soils³ | soils⁴ | soils⁵ | soils⁶ |
| Boreal | 68 | NA | 10⁸ | 117 | 20⁸ | 146 |
| Cold temperate, dry | 50 | 33 | 34 | NA | 20⁸ | 87 |
| Cold temperate, moist | 95 | 85 | 71 | 115 | 130 | |
| Warm temperate, dry | 38 | 24 | 19 | NA | 70⁸ | 88 |
| Warm temperate, moist | 88 | 63 | 34 | NA | 80 | |
| Tropical, dry | 38 | 35 | 31 | NA | 50⁸ | 86 |
| Tropical, moist | 65 | 47 | 39 | NA | 70⁸ | |
| Tropical, wet | 44 | 60 | 66 | NA | 130⁸ | |
| Tropical montane | 88* | 63* | 34* | NA | 80* | |

Ref: IPCC V4_02_Ch2_Generic.pdf, Page 2.31, Table 2.3

F_{LU} may represent a farm land use value. In an embodiment, the F_{LU} value may be based on the IPCC table below and whether the field is being utilized for long-term cultivated cropland or a short-term/set aside cropland. Specifically, the climate region and the type of field usage may be utilized as input to a table below to determine the F_{LU} values for field A and field B.

FLU

| | Long-term cultivated | Short-term or set aside |
|---|---|---|
| Climate Region | cropland | cropland |
| Boreal | 0.80 | 0.82 |
| Temperate Cold Dry | 0.80 | 0.93 |
| Temperate Cold | 0.69 | 0.82 |
| Moist | | |
| Temperate Warm Dry | 0.80 | 0.93 |
| Temperate Warm | 0.69 | 0.82 |
| Moist | | |
| Tropical Dry | 0.58 | 0.93 |
| Tropical Moist | 0.48 | 0.82 |
| Tropical Montane | 0.64 | 0.88 |
| Tropical Wet | 0.48 | 0.82 |

F_{MG} may represent a farm management value. In an embodiment, the F_{MG} value may be based on the IPCC table below. Specifically, the climate region and the type of tillage used in the field may be utilized as input to a table below to determine the F_{MG} values for field A and field B.

FMG- Cropland

| Climate Region | Full Tillage | Reduced Tillage | No Till |
|---|---|---|---|
| Boreal | 1.00 | 1.02 | 1.10 |
| Temperate Cold Dry | 1.00 | 1.02 | 1.10 |
| Temperate Cold | 1.00 | 1.08 | 1.15 |
| Moist | | | |
| Temperate Warm | 1.00 | 1.02 | 1.10 |
| Dry | | | |
| Temperate Warm | 1.00 | 1.08 | 1.15 |
| Moist | | | |
| Tropical Dry | 1.00 | 1.09 | 1.17 |
| Tropical Moist | 1.00 | 1.15 | 1.22 |
| Tropical Montane | 1.00 | 1.09 | 1.16 |
| Tropical Wet | 1.00 | 1.15 | 1.22 |

Ref: IPCC V4_05_Ch5_Cropland.pdf, Page 5.17, Table 5.5

F₁ represents a field input value. In an embodiment, the F₁ value may be based on various input values associated with the field to classify the field as one of (1) low residue usage, (2) medium residue usage, (3) high residue usage without animal manure, or (4) high residue usage with animal manure. In an embodiment, the classification may be provided as user input. Once the field is classified, the climate region of the field and the classification may be utilized as input to the below IPCC table to determine the F₁ value for fields A and B.

FI - Cropland

| | | | HIGH | HIGH |
|---|---|---|---|---|
| | | | WITHOUT | WITH |
| | | | ANIMAL | ANIMAL |
| Climate Region | LOW | MEDIUM | MANURE | MANURE |
| Boreal | 0.95 | 1.0 | 1.04 | 1.37 |
| Temperate Cold | 0.95 | 1.0 | 1.04 | 1.37 |
| Dry | | | | |
| Temperate Cold | 0.92 | 1.0 | 1.11 | 1.44 |
| Moist | | | | |
| Temperate Warm | 0.95 | 1.0 | 1.04 | 1.37 |
| Dry | | | | |
| Temperate Warm | 0.92 | 1.0 | 1.11 | 1.44 |
| Moist | | | | |
| Tropical Dry | 0.95 | 1.0 | 1.04 | 1.37 |
| Tropical Moist | 0.92 | 1.0 | 1.11 | 1.44 |
| Tropical Montane | 0.94 | 1.0 | 1.08 | 1.41 |
| Tropical Wet | 0.92 | 1.0 | 1.11 | 1.44 |

Ref: IPCC V4_05_Ch5_Cropland.pdf, Page 5.18, Table 5.5

Accordingly, the evaluation module 126 may determine the A value, the SOC_{REF} value, the F_{LU} value, the F_{MG} value, and the F_{I} value for field A and Field B of Lee's Farm utilizes the tables in the manner described above. These values may then be utilized in the formula above to determine the annual change in organic carbon stock in mineral soils (ΔC_{Mineral}) for each of field A and field B of Lee's Farm. As such, the ΔC_{Mineral} value, determined according to the one or more embodiments as described herein, can indicate the impact of particular'arm/product/field characteristics on the carbon sequestration of the field.

In addition or alternatively, other characteristics of the soil and trees that are within the field may be utilized to more accurately determine the carbon sequestration value of the field. For example, the weight, age, etc. of each tree in the field may be utilized by the evaluation module 126 to further modify the carbon sequestration value that is determined as described above. As another example, a measure of the soil organic matter (SOM) in the soil of the field may be utilized to further modify the carbon sequestration value. Therefore, although the examples as described herein calculate the ΔC_{Mineral} value to determine or quantify an amount of carbon that is sequestered at a field, it should be understood that different or additional characteristics (e.g., farm, field, and/or product characteristics) may be considered in a variety of different ways (e.g., utilizing different formulas) to determine a value that is indicative of the amount of carbon that is sequestered at a field according to the one or more embodiments as described herein.

Therefore, and this example, let it be assumed that the carbon sequestration value for field A of Lee's Farm is determined to be 2.8025 tCO2e per year from soil based on the formula above. Further, let it be assumed that the carbon sequestration value for field A for Lee's Farm is determined to be 24.12 tCO2e per year from tree based sequestration. Therefore, total carbon sequestration value for field A is 26.93 tCO2e per year, where field A is 1 Hectare (Ha). This value is determined, based on, for example, the ΔC_{Mineral} value determined for field A, as well as additional properties of the soil in field A and the tree characteristics in field A. Further, let it be assumed that the carbon sequestration value for field B of Lee's Farm is similarly determined to be 40.39 tCO2e per year from soil and tree based sequestration, where field B is 1.5 Ha.

### Calculating Carbon Footprint Data (e.g., Value) at the Field Level

The evaluation module 126 may calculate the carbon footprint value for a field based on the calculated carbon emission value and the calculated carbon sequestration value for the field. In an embodiment, the carbon sequestration value may be subtracted from the carbon emission value to determine the carbon footprint value for the field. A carbon footprint value that is positive indicates that the field is emitting more carbon than is being sequestered. As such, a positive carbon footprint value is analogous to being climate negative. A carbon footprint value that is negative indicates that the field is sequestering more carbon than is being emitted. As such, a negative carbon footprint value is analogous to being climate positive. A carbon footprint value that is a value of zero or a value that is substantially zero indicates that the amount of carbon being emitted and sequestered at the field is the same or substantially the same. As such, a zero-carbon footprint value is analogous to being climate neutral.

In the example as described herein, the carbon emission value determined for field A of Lee's Farm is 4.869 tCO2e. Additionally, the carbon sequestration value for field A of Lee's Farm is 26.93 tCO2e. Therefore, the carbon footprint value for field A is −22.061 tCO2e (e.g., the carbon emission value — the carbon sequestration value). Field A of Lee's Farm is climate positive since the carbon footprint value is a negative value.

The carbon emission value determined for field B of Lee's Farm is 2.517 tCO2e. Additionally, the carbon sequestration value for field B of Lee's Farm is 40.39 tCO2e. Therefore, the carbon value for field B is −37.873 tCO2e (e.g., the carbon emission value−the carbon sequestration value). Field B of Lee's Farm is climate positive since the carbon footprint value is a negative value. Because the carbon footprint value of field B is a larger negative value than the carbon footprint value of field A, field B is more climate positive than field A. Stated another way, the ratio of carbon sequestered vs. carbon emitted at field B is greater than the ratio of carbon sequestered vs. carbon emitted at field A.

The examples above describe determining the carbon footprint at field A and field B of Lee's Farm that produces blueberries. However, it is expressly contemplated that the carbon footprint may also be determined at one or more different points in time along the lifecycle of the blueberries where the blueberries may be further processed, stored, and then eventually provided to a store for sale to consumers. The different carbon footprints that are determined along the lifecycle of the blueberries may be aggregated at each stage of the lifecycle to construct a carbon ledger for the blueberries.

For example, let it be assumed that the blueberries that are produced from field A of Lee's Farm are transported By Dennis' Trucking Company to Mike's storage Center in San Francisco. Trent's Food Trucking Company then transports the blueberries from Mike's Storage Center to Frank's Grocery Store. According to the one or more embodiments as described herein, the evaluation module 126 may determine a carbon footprint value, in a similar manner as described above, for (1) the transportation by Dennis' Trucking Company, (2) storage of the Blueberries at Mike's Storage Center, (3) transportation by Trent's Trucking Company, and (4) storage/maintenance of the blueberries on the shelf at Frank's Grocery Store. For example, the evaluation module 126 may determine a value that indicates the amount of carbon that is emitted by each truck of Dennis' Trucking company that is utilized to transport the blueberries to Mike's Storage Center. Similarly, the evaluation module 126 may determine a carbon sequestration value and a carbon emission value for Mike's Storage Center based on the practices implemented to store the blueberries at Mike's Storage Center.

For example, the type and amount of energy required to refrigerate the blueberries at Mike's Storage Center may be utilized to determine the impact that refrigerating the blueberries has on the carbon emitted at Mike's Storage Center. Even more, the evaluation module 126 may determine the carbon sequestration value and/or carbon emission value for the store of the seller who is selling the blueberries to consumers. As such, and according to the one or more embodiments as described herein, the carbon footprint for manufacturing, processing, and storing the blueberries can be determined at each stage of the lifecycle. Additionally, the carbon footprint can be aggregated along the different stages of the lifecycle to provide an indication regarding the total carbon effect on the environment for producing the blueberries and providing the blueberries to consumers for purchase.

The evaluation module 126 may generate an electronic carbon ledger that includes an entry for each of the determined carbon footprints, an entry for the carbon footprint value as it changes at each stage in the lifecycle of the blueberries, and/or a total carbon footprint value for the blueberries at the end of the lifecycle (e.g., the blueberries are placed on the shelf at Frank's Grocery Store) that is based on a summation of all of the determined carbon footprints.

In an embodiment, different characteristics of the farm/product/field may be modified by the user on the fly and in real-time. In response, the evaluation module 126 may, automatically, adjust the one or more determined carbon footprint values. Advantageously, the user can understand, in real-time, how different changes can affect the one or more determined carbon footprint values of a field. This understanding allows the user to implement changes to improve their carbon footprint.

For example, evaluation module 126 may determine a carbon footprint for each of fields A and B of Lee's farm in the manner described above. Based on the determined and displayed carbon footprint values, the entity operating fields A and B may change one or more practices to, for example, improve the carbon footprint at fields A and B. In an embodiment, the evaluation module 126 may display one or more suggested practices (i.e., actions) that can be implemented to improve the carbon footprint at fields A and/or B. For example, and instead of using the three current pesticides at field A of Lee's Farm as described above, the evaluation module 126 may suggest that a different pesticide be used at field A to improve the carbon footprint at field A.

Although the example refers to using a different pesticide than that which is currently being used at Field A, it is expressly contemplated that any of a variety of different field actions (e.g., different irrigation technique, different field management system, etc.) can be suggested to improve the carbon footprint at the field level. To identify one or more different suggestions that would improve the carbon footprint at field A, the evaluation module 126 may generate the carbon footprint for field A with different potential field actions that might be implemented. The evaluation module 126 may compare the different generated scores to select optimal suggestions that are most similar to the currently implemented actions and that have the largest impact, e.g., have a largest effect on improving the carbon footprint, at field A.

As another example, the carbon calculator may indicate that fields A and B are both carbon negative (e.g., climate positive). Thus, fields A and B may have carbon credits. Because of the carbon credits, the entity operating fields A and B may determine that a cheaper, yet more carbon positive, transportation service from fields A and B to a storage facility can be used. Therefore, the carbon calculator according to the one or more embodiments as described herein allows the entity to take advantage of the determined credits to save financial resources relating to the operation of fields A and B.

Accordingly, different practices can be implemented at the field level based on the output of the carbon calculator according to the one or more embodiments as described herein. Because the carbon calculator as described herein allows for better carbon related decisions to be made at the field level, the one or more embodiments as described herein have a practical effect and impact in the emerging and developing technology of carbon footprint technology.

### Illustrative Example for Operation of Carbon Calculator for Shrimp

In this example, the carbon calculator may be utilized to calculate carbon footprint value for a shrimp farm at a particular geographical location (e.g., longitude and latitude). In an embodiment, the carbon footprint may indicate the amount of carbon emitted and/or sequestered during the harvesting of shrimp at shrimp farm or fields (e.g., ponds) of the shrimp farm.

In this example, let it be assumed that Bret owns and operates Bret's Shrimp Farm that harvests shrimps from one or more bodies of water. Further, let it be assumed that Bret has established a unique account with evaluation platform 120 in a manner as described above. As such, Bret and/or other affiliates of Bret's Shrimp Farm may access and utilize the carbon calculator according to the one or more embodiments as described herein. During the establishment of the unique account with the evaluation platform 120 or after establishing the unique account with the evaluation platform 120, Bret may utilize client device 110 to provide, i.e., input, a variety of different information that describes the attributes associated with Bret's Shrimp Farm, the attributes associated with different fields (ponds) of Bret's Shrimp Farm, and/or the attributes associated with shrimps harvested at Bret's Shrimp Farm. As will be described in further detail below, the evaluation module 126 of the evaluation platform 120 may utilize the provided information to determine the carbon footprint of Bret's Shrimp Farm. In fact, and as will be described in further detail below, the evaluation module 126 may utilize the provided information to determine different carbon footprints for two different ponds of Bret's Shrimp Farm.

### Farm (e.g., Bodie(s) of Water) Characteristics

In an embodiment, Brett may utilize one or more user interfaces, that are provided by evaluation platform 120 for display on client device 110, to provide characteristic information associated with Bret's Shrimp Farm in a similar manner as described above. For example, Bret may utilize the user interfaces to provide a name or identifier for Bret's Shrimp Farm. Additionally, Bret may utilize the user interfaces to provide a location (e.g., city, province/state, country, postal code, etc.) of Bret's Shrimp Farm. In this example, let it be assumed that Brett utilizes the user interface to indicate that the name of his farm is “Bret's Shrimp Farm” that is located at 3 Cork Lane, Seattle, WA 98101.

In a similar manner as described above with reference to the blueberries example, an API may pull the geographical location and climate condition information. In addition, Bret may be required to provide particular information that is related to shrimps or other water-dwelling products that is harvested from the bodies of water. As will be explained in further detail below, particular emission factors associated with the shrimp farm may be utilized to determine a carbon emission value of the farm/field.

In addition or alternatively, Bret may utilize the user interfaces to indicate whether and what type of farm management system, if any, is being utilized at Bret's Shrimp Farm. The evaluation module 126 may, in a similar manner as described above with respect to blueberries, access data from the farm management software that may be utilized to more accurately determine a carbon emission value and/or carbon sequestration value for Bret's Shrimp Farm. Instead of accessing the data from the farm management software by the evaluation module 126, the farm management data may be obtained via user input.

### Field (e.g., Pond) Specific Characteristics

According to the one or more embodiments as described herein, the evaluation module 126 may utilize field specific information to determine a different carbon footprint for different fields of a same shrimp farm. Although the examples as described herein refer to a pond, it is expressly contemplated that a field may be a lake, ocean, river, or any other body of water from which shrimp or other water-dwelling creatures may be captured. According to the one or more embodiments as described herein, a shrimp farm may include multiple ponds that may have different management practices. Such management practices may include, but are not limited to, water source, water treatment, feed management, farming type, etc. Bret may utilize the one or more user interfaces to provide such information to the evaluation platform 120.

In addition to utilizing management practices to determine a carbon footprint, the one or more embodiments as described herein may also utilize the physical attributes of the field to determine the carbon footprint. For example, the physical attributes may include, but are not limited to, field size, usage (Fisheries), color of the soil in the pond, texture of the soil in the pond, type of shrimp, etc.

For this example, let it be assumed that Bret's Shrimp Farm includes at least two different ponds, e.g., pond X and pond Y, from which shrimps are harvested. Further, and in this example, let it be assumed that Bret implements different farm management practices at pond X and pond Y. As such, and according to this example, Bret may utilize the one or more user interfaces to provide the pond specific characteristics for each of pond X and pond Y.

### Product Characteristics

The user may also provide product specific characteristics that can be utilized to determine the carbon footprint. In this example, Bret may utilize the one or more user interfaces, provided via client device 120, to indicate that the product is fishery. In addition, Bret may utilize the one or more user interfaces to indicate the yield quantity of the shrimps that are harvested from pond X and pond Y. Further, a start date and an end date for which the evaluation module 126 is implementing the carbon calculator for Bret's Shrimp Farm may also be provided by Bret via the user interfaces. For example, the yield quantity may be the amount of shrimp harvested over the time period (e.g., between the start date and end date) at ponds X and Y in terms of MT.

Calculating Carbon Emission Data (e.g., Value) at the Field Level (e.g., Pond) Utilizing Received or Obtained Characteristic information

In an embodiment, the management practices implemented at the pond can be utilized to determine a carbon emission value for the pond that is attributed to the management practices. For example, a carbon emission value may be calculated based on the total product yield (harvest quantity), and the amount of feeds and nutrients that are utilized in the field (pond). Type of feeds may include, but are not limited to, commercial, biological, indirect nutrients, etc. Type of nutrients may include, but are not limited to, lime, zeolite, tea meal, etc. In an embodiment, the carbon emissions attributable to the feeds and nutrients may be calculated as:

Carbon Emissions from Shrimp Feed=Product Yield×EF for Shrimp feed

In the formula above, EF is applied (e.g., multiplied) to the quantity of total product yield. In an embodiment, the EF value for commercial feed, biological feed, and nutrient may be obtained from the table below. For example, if the feed and nutrients utilized in pond X is tea meal, it may be determined that the EF value for pond X is 0.1708 based on the table below. If the feed and nutrients utilized in the pond Y is commercial feed, the table may be utilized to determine that EF value for pond Y is 0.7023. For the carbon emission values calculated below, let it be assumed that pond X has an EF value of 0.1708 and pond Y has an EF value of 0.7023.

EF Table for shrimp feed (Commercial
feed, Biological Feed, and Nutrient)

| Default EF for | EF |
|---|---|
| Shrimp Feed | kgCO2e/kg |
| Shrimp Feeds | shrimp |
| Biological Feeds | 0.9883 |
| Commercial Feeds | 0.7023 |
| Zeolite | 1.2858 |
| Tea Meal | 0.1708 |
| Lime | 0.0216 |

As such, the above formula may be utilized to determine the affect/impact of the feed and nutrients have on the carbon emission of a field, e.g., pond. In this example, and based on the formula above , let it be assumed that the evaluation module 126 calculates the carbon emission value attributable to the feeds and nutrients utilized in pond X of Bret's Shrimp Farm as 3.169 tCO2e based on a product yield of 1 Ton at Pond X .

Additionally, and based on the formula above, let it be assumed that the evaluation module 126 calculates the carbon emission value attributable to the feeds and nutrients utilized in pond Y of Bret's Shrimp Farm as 4.753 tCO2e based on a product yield of 1.5 Tons at Pond Y.

In addition to considering the feed and nutrients to determine the carbon emission for the field, the one or more embodiments as described herein may also consider the aquaculture water used in the field. Aquaculture water use is water associated with raising organisms that live in water such as finfish and shellfish for food, restoration, conservation, or sport. In an embodiment, the aquaculture water includes, but is not limited to, fresh water and marine water.

In an embodiment, the aquaculture water used in the field may affect/impact the carbon emission in the field. In an embodiment, the carbon emission attributable to the aquaculture water may be calculated as:

Carbon Emissions from Aquaculture Water Used in a Pond=Total Amount of Aquaculture Water usage in the Farm×EF for Aquaculture Water X Usage Percentage (%) in that Pond

In this example, let it be assumed that the total amount of aquaculture water used in Bret's Shrimp Farm is 50 m3. Further, let it be assumed that Pond X uses 20% (e.g., 10 m3) of the aquaculture water. Therefore, and based on the formular above, the evaluation module 126 may calculate the carbon emission value attributable to the aquaculture water used in pond X to be as 0.0038 tCO2e.

Further, let it be assumed that Pond Y uses 30% (e.g., 15 m3) of the aquaculture water of Bret's Shrimp Farm. Therefore, the evaluation module 126 may calculate the carbon emission value attributable to the aquaculture water used in pond Y as 0.0056 tCO2e.

In addition to considering the feed and nutrients and aquaculture water to determine the carbon emission for the field, the one or more embodiments as described herein may also consider the energy that is used in the field. In an embodiment, the energy may be fuel and/or electricity. In an embodiment the carbon emission attributed to energy used in the field may be based on one or more of (1) what the energy is being used for in the field (e.g., transport, irrigation, operation, etc.), (2) type of energy being used in the field (e.g., fossil fuel, biomass, natural gas, electricity, etc.), (3) name of the energy type (e.g., diesel, petrol, liquefied natural gas (LNG), propane, state grid, etc.), (4) usage quantity.

For example, if fuel is utilized in the field, the one or more embodiments as described herein may calculate the impact/effect that the fuel has on the carbon emission produced at the field based on:

Carbon Emissions from the usage of Fuels in a Pond=Amount of Fuel used×EF for the usage of fuel×Usage Percentage of Fuels in that Pond

If electricity is utilized in the field, the one or more embodiments as described herein may calculate the impact/effect that the electricity has on the carbon emission produced at the field based on:

Emissions from the usage of Electricity in a Pond=Amount of Electricity Used×EF for the Usage of Electricity×Usage Percentage of Electricity in that Pond

In this example, let it be assumed that pond X utilizes both fuel energy and electric energy. As such, the evaluation module 126 may utilize both of the above formulas to, respectively, calculate the impact/effect that fuel energy and electric energy has on the carbon emission produced at pond X. For this example, let it be assumed that the total fuel usage at Bret's Shrimp Farm is 1000 liter and pond X uses 10% of the fuel at Bret's Shrimp Farm. Therefore, and based on the formula above, the carbon emission attributable to fuels (Diesel) used at pond X is 0.285 tCO2e. Let it further be assumed that the total electricity usage at Bret's Shrimp Farm is 1000 Kwh and pond X uses 10% of the electricity at Bret's Shrimp Farm. Therefore, and based on the formula above, the carbon emission attributable to electricity used at Pond X is 0.043 tCO2e. As such, the evaluation module 126 may sum these values together to determine the total impact that the energy usage has on the carbon emission produced at pond X. In this example, the total impact that the energy usage has on the carbon emissions produced at pond X is 0.328 tCO2e.

Further, let it be assumed that pond Y only utilizes electric energy. For this example, let it be assumed that pond Y uses 20% of the electricity of Bret's Shrimp Farm. As such, the evaluation module 126 may calculate the impact/effect that electrical energy has on the carbon emission produced at pond Y. For this example, let it be assumed that carbon emission attributed to electricity used at pond Y is 0.086 tCO2e.

In addition, a carbon emission value may be calculated for the refrigeration or cooling that is used to, for example, store the shrimp captured from the pond X and pond Y. In an embodiment, the evaluation module 126 may multiply the amount of refrigerant, in kg/1000, with a particular GWP factor. In an embodiment, the GWP factor may be determined based on the type of Hydrofluorocarbon (HFC) used for the refrigeration. For example, the following table may be utilized to select a particular GWP factor based on the type (e.g., HFC-23) of HFC used for the refrigeration.

EF of HFC's used in refrigeration

| HFC's used in | |
|---|---|
| Refrigeration | GWP in t Co2-e/t |
| HFC-23 | 12400 |
| HFC-32 | 677 |
| HFC-41 | 116 |
| HFC-43-10mee | 1650 |
| HFC-125 | 3170 |
| HFC-134 | 1120 |
| HFC-134a | 1300 |
| HFC-143 | 328 |
| HFC-143a | 4800 |
| HFC-152a | 138 |
| HFC-227ea | 3350 |
| HFC-236fa | 8060 |
| HFC-245ca | 716 |
| HFC-245fa | 858 |
| HFC-365mfc | 804 |

For this example, let it be assumed that 100 kg of HFC 23 has been used at Bret's Shrimp Farm. Further, let it be assumed that pond X uses 10% of the HFC 23 used at Bret's Shrimp Farm and pond Y uses 20% of the HFC 23 used at Bret's Shrimp Farm. The evaluation module 126 determines that the carbon emission value attributed to refrigerating the shrimps harvested at pond X is 124 tCO2e. Further, let it be assumed that the evaluation module 126 determines that the carbon emission value attributed to refrigerating the shrimps harvested at pond Y is 248 tCO2e.

The evaluation module 126 may sum the individual carbon emission values determined for a pond to determine a total carbon emission value for the pond. Therefore, and in this example, the evaluation module 126 determines that the total carbon emission value for pond X of Brett's Shrimp farm is 127.50 tCO2e. Specifically, the total carbon emission value is a sum of (1) the carbon value determined for the feeds and nutrients used at pond X, (2) the carbon value determined for the aquaculture water used at pond X, (3) the carbon value determined for the energy, e.g., fuel and electricity, used at pond X, and (4) the carbon value determined for the refrigeration used for the shrimps harvested at pond X. The evaluation module 126 may determine, in a similar manner, that the total carbon emission value for pond Y of Brett's Shrimp Farm is 252.84 tCO2e.

Therefore, and in this example, a different carbon emission value can be calculated for pond X and pond Y of Brett's Shrimp Farm based on the specific characteristics of each pond. Although the examples as described herein for Brett's Shrimp Farm determine the carbon emission values for a pond based on the feeds and nutrients, the aquaculture water, the energy used, and the refrigeration used, it is expressly contemplated that fewer or additional farm/product/field characteristics may be utilized to determine the carbon emission value for a field, i.e., pond, according to the one or more embodiments as described herein.

For example, in addition to considering feeds and nutrients, the aquaculture water, the energy used, and the refrigeration used, the evaluation module 126 may also consider refrigeration leakage, waste management procedures used at the pond (e.g., recycling of empty packages, disposal of shrimp head and shell), and/or wastewater treatment used at the pond. As such, the examples as described herein are for illustrative purposes only, and it should be expressly understood than any of a variety of different farm/product/field (pond) characteristics may be utilized to determine the carbon emission value according to the one or more embodiments as described herein.

Calculating Carbon Sequestration Data (e.g., Value) at the Field Level (e.g., Pond) Utilizing Received or Obtained Characteristic information

In addition to calculating the carbon emission value for a pond in the manner described above, the evaluation module 126 may also calculate a carbon sequestration value. In this example, let it be assumed that the carbon sequestration values for pond X and pond Y are 0. However, it should be understood that in alternative embodiments, the carbon sequestration value for the ponds may be determined based on a variety of different farm/product/field (pond) characteristics according to the one or more embodiments as described herein. As another example, if the product being produced was meat instead of shrimp, the carbon sequestration value may also be calculated in a similar manner as described herein.

### Calculating Carbon Footprint Data (e.g., Value) at the Field Level (e.g., Pond)

The evaluation module 126 may calculate the carbon footprint value for a pond based on the calculated carbon emission value and the calculated carbon sequestration value for the pond.

In an embodiment, the carbon sequestration value may be subtracted from the carbon emission value to determine the carbon footprint value for the pond. A carbon footprint value that is positive indicates that the pond is emitting more carbon than is being sequestered. As such, a positive carbon footprint value is analogous to being climate negative. A carbon footprint value that is negative indicates that the pond is sequestering more carbon than is being emitted. As such, a negative carbon footprint value is analogous to being climate positive. A carbon footprint value that is a value of zero or a value that is substantially zero indicates that the amount of carbon being emitted and sequestered at the pond is the same or substantially the same. As such, a zero-carbon footprint value is analogous to being climate neutral. Since the carbon sequestration values for pond X and pond Y are 0, the carbon footprint value for pond X and the carbon footprint value for pond Y are equal to, respectively, the carbon emission value calculated for pond X and pond Y. Thus, the carbon footprint value for pond X is 127.50 tCO2e and the carbon footprint value for pond Y is 252.84 tCO2e. As such, both ponds are carbon negative and pond Y is more carbon negative than pond X.

The examples above describe determining the carbon footprint at pond X and pond Y of Brett's Shrimp Farm. However, it is expressly contemplated that the carbon footprint may also be determined at one or more different points in time along the lifecycle of the shrimps where the shrimps may be further processed, stored, and then eventually provided to a store for sale to consumers. The different carbon footprints that are determined along the lifecycle of the shrimps may be aggregated at each stage of the lifecycle to construct a carbon ledger for the shrimps.

For example, let it be assumed that the shrimps that are harvested at pond X of Brett's Shrimp Farm are transported By Dennis' Trucking Company to Mike's storage Center in San Francisco. Trent's Food Trucking Company then transports the shrimps from Mike's Storage Center to Frank's Grocery Store. According to the one or more embodiments as described herein, the evaluation module 126 may determine a carbon footprint value, in a similar manner as described above, for (1) the transportation by Dennis' Trucking Company, (2) storage of the Shrimps at Mike's Storage Center, (3) transportation by Trent's Trucking Company, and (4) storage/maintenance of the Shrimps in a refrigerator/freezer at Frank's Grocery Store. For example, the evaluation module 126 may determine a value that indicates the amount of carbon that is emitted by each truck of Dennis' Trucking company that is utilized to transport the shrimps to Mike's Storage Center. Similarly, the evaluation module 126 may determine a carbon sequestration value and a carbon emission value for Mike's Storage Center based on the practices implemented to store the shrimps at Mike's Storage Center.

For example, the type and amount of energy required to refrigerate the shrimps at Mike's Storage Center may be utilized to determine the impact that refrigerating the shrimps has on the carbon emitted at Mike's Storage Center. Moreover, the evaluation module 126 may determine the carbon sequestration value and/or carbon emission value for the store of the seller who is selling the shrimps to consumers. As such, and according to the one or more embodiments as described herein, the carbon footprint for manufacturing, processing, and storing the shrimps can be determined at each stage of the lifecycle. Additionally, the carbon footprint can be aggregated along the different stages of the lifecycle to provide an indication regarding the total carbon effect on the environment for producing the shrimps and providing the shrimps to consumers for purchase.

The evaluation module 126 may generate an electronic carbon ledger that includes an entry for each of the determined carbon footprints, an entry for the carbon footprint value as it changes at each stage in the lifecycle of the shrimps, and/or a total carbon footprint value for the shrimps at the end of the lifecycle (e.g., the shrimps are placed in a refrigerator/freezer at Frank's Grocery Store) that is based on a summation of all of the determined carbon footprints.

In an embodiment, different characteristics of the farm/product/field may be modified by the user on the fly and in real-time. In response, the evaluation module 126 may, automatically, adjust the one or more determined carbon footprint values. Advantageously, the user can understand, in real-time, how different changes can affect the one or more determined carbon footprint values of a field. This understanding allows the user to implement changes to improve their carbon footprint.

Therefore, the carbon footprints determined according to the one or more embodiments as described herein can have a granularity that is pond level specific. This is in contrast to some conventional systems that can only determine a single carbon footprint for a plurality of different ponds that are within the same general location. In contrast, the one or more embodiments as described herein can determine a different carbon footprint for each of the different ponds located in the same general location. Moreover, the one or more embodiments as described herein provide the robustness and granularity to even determine different carbon footprints for different ponds of the same farm. As such, the one or more embodiments as described herein provide an improvement in the existing technological field of carbon capture technology. By determining the carbon footprint at the pond level, entities that produce products, e.g., shrimps, can better understand their true carbon footprint and the effect of their farm on the environment. This in turn allows entities with the ability to better implement practices to improve the environmental footprint for the pond or ponds in which the product is produced, processed, and/or stored. As such, the one or more embodiments as described herein provide an improvement in the field of electronic Green House Gas (GHG) measurement technology.

By generating the carbon footprint at a pond level granularity instead of at a farm level as is done with some conventional systems, the one or more embodiments as described herein are integrated into a practical application. That is, a carbon calculator that can determine a carbon footprint at the pond level is a practical application in emerging and developing technologies of carbon capture technology, electronic GHG measurement/management technology, and/or electronic carbon measurement/management technology. Specifically, the carbon calculator according to the one or more embodiments as described herein allows better carbon related decisions to be made at the pond level thus impacting carbon emissions technology.

### Illustrative Example for Determining Authenticity of Product

The evaluation module 126 may generate a genetic fingerprint for a product (e.g., seed, blueberry, plant, shrimp) through use of a selected set of molecular markers (e.g., 12-24 molecular markers). For example, the inventive technique may select a particular number of markers for a particular plant species based on an evaluation of different factors. Specifically, the inventive technique may evaluate the hundreds of molecular markers to select those markers for the plant species such that (1) the selected markers are spread throughout the genome so that enough chromosomes can be represented, and (2) the markers can sufficiently differentiate between different varieties of the plant species.

Therefore, and when a plant variety of the species is harvested, the inventive technique may analyze the plant to generate a genetic fingerprint for that plant based on the selected markers. Specifically, the analysis may result in generation of a genetic fingerprint for the plant variety based on the selected markers where the values of the molecular markers are unique to the plant variety, e.g., unique values when compared to the genetic fingerprints generated of other varieties of the plant species that utilize the same molecular markers for their genetic fingerprints. The genetic fingerprint for each of the plurality of plant varieties may be stored with a unique identifier in a database. A similar process may occur for different varieties of other plant species. Further, a similar process may occur for any type of product during.

Thereafter, the inventive technique can perform an analysis on the seed, produced from the harvest, to produce a new genetic fingerprint at any point in the lifecycle from the seed to the plant (e.g., stored before being sold to farmer, when farmer buys it, prior to implantation, after implantation during growth, after harvesting, during storage at one or more locations, during transportation, and/or during time at merchant store prior to purchase by consumer). The new genetic fingerprint may be compared (e.g., comparing the molecular markers) to the corresponding fingerprint stored in the database to ensure that the seed is in fact what it is purported to be and to ensure the purity of the ingredient (e.g., the seed has not been degraded). For example, and as will be described in further detail below, the authenticity of a product (e.g., comparison as described herein) may be utilized by a consumer in making a purchasing decision.

In an embodiment, authenticity may relate to determining whether a product is in fact treated (e.g., prepared, produced, stored, transported, etc.) in a manner that is consistent with a consumer's expectation. For example, a product may be classified as being a vegetarian product. However, the term “vegetarian” may be an overarching term that may mean different things to different consumers. For example, some consumers may interpret a vegetarian product as being any product that is not a meat product. This may be considered a less strict interpretation of the term “vegetarian” as it relates to a consumer product. Other consumers may interpret a vegetarian product as being a product that has had no direct or indirect contact with any meat products during its entire lifecycle. This would be a stricter interpretation of the term “vegetarian” as it relates to a consumer product. Thus, different consumers may have different expectations as it relates to how a product for purchase is defined, which may affect the consumer's purchasing decisions. However, and with conventional systems, the degree to which a product conforms to a particular classification (e.g., vegetarian product) is not typically available to a consumer while in a store when the consumer is making a purchasing decision.

According the one or more embodiments as described herein, a product may be tracked or evaluated during the entirety of the product's lifecycle such that the degree to which a product conforms to a particular classification may be utilized by the consumer to make a purchasing decision.

For example, supposed that Lee's Farm, that is registered with the evaluation platform 102, also harvests lettuce and the lettuce at Lee's farm is not harvested with any manure from animals. Lee's Farm may indicate as such to the evaluation platform 102 utilizing a client device as described above. Let it be assumed for this example that a trucking company, that is registered with the evaluation platform 102, transports the lettuce from Lee's Farm to a store where the lettuce will be purchased by consumers.

Further, in this example, the lettuce is transported in a truck that was previously utilized to transport poultry to a different store. The trucking company may indicate as such to the evaluation platform 102 utilizing a client device as described above. Moreover, let it be assumed that the store at which the lettuce is sold ensures that the lettuce is completely segregated from all meat products prior to and during shelving at the store. The store may indicate as such to the evaluation platform 102 utilizing a client device as described above.

Therefore, the evaluation module 126 may determine the different practices that are implemented at each point along the lifecycle of the lettuce. As such, the evaluation module 126 can determine the degree to which a product conforms to a particular classification (e.g., being a vegetarian product). Therefore, the information may be provided to the consumer such that the consumer may make an informed purchasing decision. For example, a consumer that has a lest strict interpretation of the term “vegetarian”, as described above, may decide to purchase Lee's lettuce since Lee's lettuce conforms to the consumer's definition of “vegetarian”. However, a consumer with a stricter interpretation of the term “vegetarian”, as described above, may decide to buy a different brand of lettuce since Lee's lettuce does not conform to the consumer's definition of “vegetarian”. Therefore, the authenticity information may be used by the consumer to determine if the product meets or aligns with the consumer's expectations such that the consumer can make an informed purchasing decision as described herein.

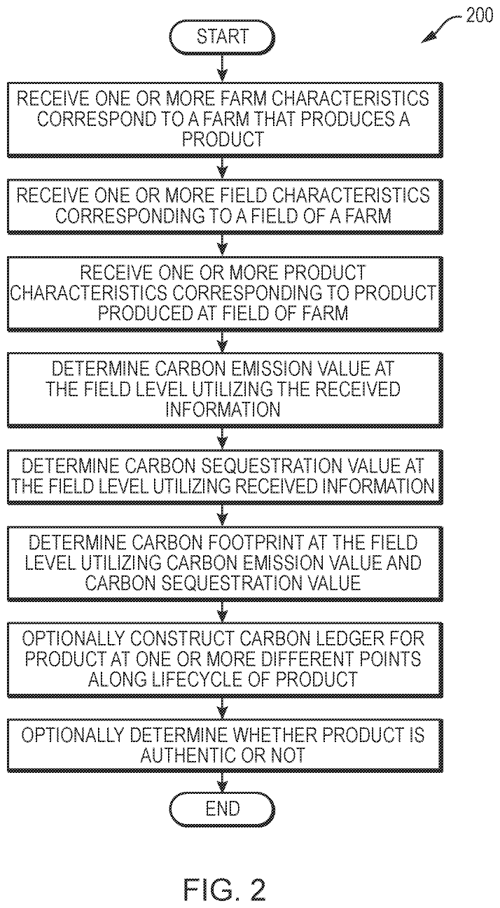

FIG. 2 is a flow diagram of a sequence of steps for determining a carbon footprint at a field level granularity according to the one or more embodiments as described herein. The procedure 200 starts at step 205 and continues to step 210. At step 210, the evaluation platform 120 receives one or more farm characteristics corresponding to a farm that produces a product. For example, the farm characteristics may be similar to those as described above with reference to the Lee's Blueberry Farm and/or Bret's Shrimp Farm. Alternatively, the farm characteristics may be any of a variety of different farm characteristics that describe a farm that produces a product.

The procedure 200 continues from step 210 to step 215. At step 215, the evaluation platform 120 receives one or more field characteristics corresponding to a field of the farm. For example, the field characteristics may be similar to those as described above with reference to fields A and b of Lee's Blueberry Farm and/or ponds X and Y of Bret's shrimp farm. Alternatively, the field characteristics may be any of a variety of different field characteristics that describe a field corresponding to a farm that produces a product.

The procedure 200 continues from step 215 to step 220. At step 220, the evaluation platform 120 receives one or more product characteristics corresponding to the product produced at the field of the farm. For example, the product characteristics may be similar to those as described above with reference to blueberries and/or shrimps. Alternatively, the product characteristics may be any of a variety of different product characteristics that describe a product produced at a farm.

The procedure 200 continues from step 220 to step 225. At step 225, the evaluation module 126 determines (i.e., calculates) a carbon emission value at the field level utilizing the received information. For example, the carbon emission value may be determined based on the farm characteristics, field characteristics, and/or product characteristics in a similar manner as described above in relation to Lee's Blueberry Farm and/or Bret's Shrimp Farm.

The procedure 200 continues from step 225 to step 230. At step 230, the evaluation module 126 determines (i.e., calculates) a carbon sequestration value at the field level utilizing the received information. For example, the carbon sequestration value may be determined based on the farm characteristics, field characteristics, and/or product characteristics in a similar manner as described above in relation to Lee's Blueberry Farm and/or Bret's Shrimp Farm.

The procedure continues from step 230 to step 235. At step 235, the evaluation module 126 determines (i.e., calculates) a carbon footprint value at the field level utilizing the carbon emission value and the carbon sequestration value. For example, the carbon footprint value may be determined at the field level in a similar manner as described above in relation to fields A and B Lee's Blueberry Farm and/or Ponds X and Y of Bret's Shrimp Farm.

The procedure 200 optionally continues from step 235 to step 240. At step 240, the evaluation module 126 optionally constructs a carbon ledger for a product at one more different points along the lifecycle of the product. The procedure 200 optionally continues from step 240 to step 245. At step 245, the evaluation module 126 optionally determines whether a product is authentic or not at one or more points along the lifecycle of the product. The procedure then ends at step 250.

### Consumer Journey

According to the one or more embodiments as described herein, the determined carbon values (e.g., carbon emission values, the determined carbon sequestration values, and the determined carbon footprint values) may be utilized by one or more consumers to make purchasing decisions. Specifically, and as will be described in further detail below, a consumer may utilize one or more user interfaces, associated with the evaluation platform 120, to provide specific information that is related to a product to be purchased by the consumer from a vendor (e.g., store or online source). For example, the customer specific information may be characteristics of importance to the customer that define (1) the practices used to produce, process, an/or store the product during the product's lifecycle, (2) practices implemented by a vendor in running a business (e.g., wages paid to employees, environmental practices, etc.), (3) characteristics of the product itself (e.g., whether the product is organic, etc.), and/or (4) customer specific information (e.g., lactose intolerance, vegan, vegetarian, etc.).

According to the one or more embodiments as described herein, and as will be described in further detail below, the evaluation module 126 may utilize the provided information with at least one of the determined carbon values to generate a customer specific score. As such, the customer specific score is tailored to meet the customer's needs such that the customer can make the most informed purchasing decision.

The examples as described herein may generate a customer score based on particular information and particular carbon values. However, the examples are for illustrative purposes only, and it should be expressly understood that any of a variety of different types of information may be utilized with a carbon value to, for example, generate a customer score according to the one or more embodiments as described herein.

As an illustrative example, let it be assumed that a customer named Glen is grocery shopping at Frank's Grocery Store. Glen is a vegetarian who is health conscious and is interested in health trends as well as the impact that the production of products has on the environment. In this example, let it be assumed that Glen has registered with the evaluation platform 120, downloaded a mobile application from the evaluation platform 120, and signed into his account. As such, Glen may utilize the functionalities provided by the evaluation platform 120 through use of the mobile application downloaded and installed on his mobile device.

As described herein, each of the steps performed by Glen to implement a function provided by the evaluation platform 120 may be performed via the mobile application. However, for simplicity and ease of understanding, the description may not explicitly state that a step is performed through use of the application. As such, it should be expressly understood that each user performed step may be performed through use of the mobile application that is, for example, installed and executing on a device (e.g., mobile device, personal computer, laptop, tablet, etc.).

Referring to the example, Glen may enter Frank's Grocery Store and may be interested in purchasing blueberries. As such, Glen may walk to the produce section of Frank's Grocery Store and find the blueberry section that includes blueberries form a plurality of different farmers, i.e., manufacturers. In this example, let it be assumed that there are 3 manufacturers. The first blueberry manufacturer is Lee's Farm. The second and third blueberry manufacturers are, respectively, Tank's BB Village and Ken's BB Farm.

According to the one or more embodiments as described herein, Glen may scan a code (e.g., QR code) on the different blueberry packages of the different blueberry products that have been evaluated by evaluation platform 120. Based on the scan, the evaluation module 126 may generate information and provide that information for display on Glen's mobile phone, where the information may indicate which product best meets Glen's needs/standards. Glenn may then utilize the information provided by the evaluation platform 120 to make a purchasing decision as will be described in further detail below.

According to the one or more embodiments as described herein, after the carbon values are generated for a product and stored by the evaluation platform 120, the product may be provided with a code, e.g., QR code, such that the generated carbon values for the product can be obtained based on the scan of the QR code on the product. In this example, let it be assumed that the blueberries from Lee's Farm and the blueberries from Tank's BB Village have been evaluated by the evaluation platform 120 to generate the carbon values as described herein. However, in this example, the blueberries from Ken's BB Farm have not been evaluated by the evaluation platform 120.

Because the blueberries from Ken's BB Farm have not been evaluated by evaluation platform 120, the carbon values that are generated according to the one or more embodiments as described herein are not generated for the blueberries from Ken's BB Farm. As such, Glen's evaluation of the blueberries from Ken's BB Farm is limited to the physical appearances of the blueberries and/or the information on the packaging label. In this situation, and because Glen is health conscious and concerned with the environment, Glen may decide that he will not buy blueberries from Ken's BB Farm because the carbon footprint and/or other information associated with the production/processing/storage of the blueberries from Ken's BB Farm cannot be ascertained. Because Glen will not purchase the blueberries from Ken's BB Farm, Ken's BB Farm may be negatively impacted financially based on Glen's decision, and likely, other consumers that may similarly want to know more about a product before purchasing it.

Therefore, manufacturers, such as Ken's BB Farm, may be financially motivated to use the evaluation platform 120 as described herein to ensure that consumers can obtain the desired information (e.g., carbon footprint values, wages paid to employees, etc.) regarding the manufacturer's products. As such, the use of the functions of the evaluation platform 120 by consumers may encourage manufacturers to also utilize the evaluation platform 120 for their products to obtain greater financial success.

Continuing with the example, Glen may utilize the one or more user interfaces to provide input as to what attributes are of importance to Glen. In this example, let it be assumed that Glen indicates, utilizing the user interfaces, that the carbon footprint value to produce/process/store a product is the only factor that Glen wants to consider when purchasing a product. Therefore, Glen may scan the QR codes on the packaging of the blueberries from Lee's Farm and Tanks BB Village. Based on the scanning of the QR codes, the evaluation module 126 may obtain one or more carbon values that are generated according to the one or more embodiments as described herein, and the values may be displayed on Glen's mobile device.

For example, the carbon footprint values for the blueberries from Lee's Farm and Tanks BB Village may be displayed on Glen's mobile device. In this example, let it be assumed that the carbon value for the blueberries from Lee's Farm is less than the carbon value for the blueberries from Tanks' BB Village. As such, the production/processing/storage of the blueberries from Lee's Farm is more climate positive than the production/processing/storage of the blueberries from Tank's BB Village. Therefore, Glen may decide to purchase the blueberries from Lee's Farm because they are more climate positive.

Because a consumer's purchasing decision may be influenced based on the carbon footprint values determined according to the one or more embodiments as described herein, entities that produce, process, and store products may be motivated to become more carbon negative, i.e., climate positive, to increase sales. As such, and through use of the evaluation platform 120 by consumers and manufacturers/processors/storers, a more climate positive environment is promoted.

Referring back to the example, let it be assumed that in addition to indicating that the carbon footprint value is of importance, Glen also utilizes the one or more user interfaces to indicate that the vegetarian products are important and that the wages paid to the employees that work at the farms where the blueberries are produced is also important. It is expressly contemplated that the information, such as wages paid and/or if a product is vegetarian, may be provided by the manufacturer and/or consumer during registration with the evaluation platform 120 as described herein. Alternatively, the information from the consumer may be provided while the consumer is utilizing the application to identify a particular product. In this example, let it be assumed that Glen has utilized the one or more user interfaces to indicate that he is interested in vegetarian products and that Glen has a strict interpretation of “vegetarian” as described herein.

Moreover, let it be assumed that Glen further indicates the priority of importance is (1) vegetarian product, (2) wages paid to employees, and (3) carbon footprint. In response to the scanning of the QR codes, the evaluation module 126 may obtain the three types of information for the blueberries from Lee's Farm and Tank's BB Village. The evaluation module 126 may then, for example, determine if the blueberries from Lee's Farm and Tank's BB village are vegetarian products as defined by Glen, e.g., blueberries that have no direct or indirect contact with any meat products during the entire lifecycle of the blueberries. The evaluation module 126 may also utilize any of a variety of different weighting algorithms to implement the provided prioritization for the three types of information that may be combined to generate a single value, e.g., customer score. That is, the customer score may be a single value that represents the evaluation of the blueberries based on the three provided factors, where the factors may be weighted based on the prioritization provided by the consumer. For example, let it be assumed that the blueberries from Lee's Farm and the blueberries from Tanks' BB village both conform to the strict definition of “vegetarian.” Further, let it be assumed that Lee's Farm pays slightly higher wages than Tank's BB Village and Lee's Farm has. Moreover, let it be assumed that the carbon footprint value for the blueberries produced at Lee's Farm is slightly higher more positive than the carbon footprint value for the blueberries produced at Tank's BB village. Since Glen has prioritized wages paid over carbon footprint, the blueberries from Lee's Farm may have a higher customer score than the customer score for the blueberries from Tank's BB Village.

As another example, and similar to the example above, let it be assumed that the blueberries from both farms conform to the strict definition of “vegetarian” and Lee's Farm pays slightly higher wages than Tank's BB village. However, let it be assumed for this example that the carbon footprint value for the blueberries produced at Lee's Farm is much more positive than the carbon footprint value for the blueberries produced at Tank's BB village. In this example the customer score for the blueberries from Tank's BB village may be higher than the customer score for the blueberries from Lee's Farm because of the great disparity between their carbon footprint values. As such, the customer score may be generated based on the criteria that is important to the consumer and based on the importance of each criterion utilizing a weighting algorithm as described herein.

Glen may then utilize the customer scores to make a purchase decision as to whether he should purchase the blueberries from Lee's Farm or From Tank's BB village.

Although the examples as described herein utilize three specific factors to generate the customer score, it is expressly contemplated that additional or less factors may also be considered to generate a customer score such that the consumer can make a purchasing decision according to the one or more embodiments as described herein. Such factors may include, but are not limited to, (1) labor practices utilized in the production, storage, and sale of the product, (2) electricity utilized in the production, storage, and sale of the product, (3) any factors that may contribute to GHG emissions, (4) absence/presence of heavy metals in the product, (5) detection of harmful pathogens in the product, (6) measurements of the nutritional value and quality of the product (e.g., ingredient), (7) age of the product, (8) contamination levels of the ingredient, (9) detection of 1-9 for the medium the product (e.g., ingredient) was grown, such as, soil or water (heavy metals, pathogens).

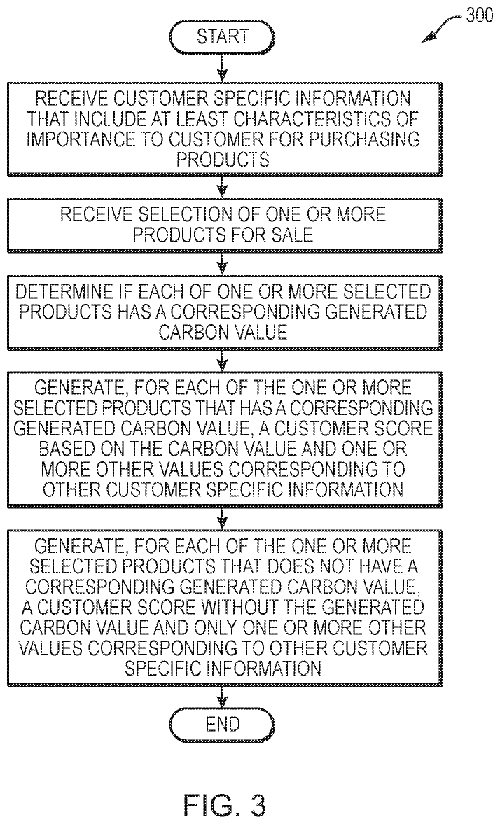

FIG. 3 a flow diagram of a sequence of steps for using customer specific information and at least one generated carbon value to generate a customer score according to the one or more embodiments as described herein. The procedure 300 starts at step 305 and continues to step 310. At step 310, the evaluation platform 120 receive customer specific information that includes characteristics of importance to a customer purchasing products. For example, and as described above, customer Glen may utilize client device 110 to indicate that (1) a carbon footprint value is important, (2) vegetarian products are important, and (3) wages paid to the employees that work at the farms where blueberries are produced is important. In an embodiment, such information may be provided by the customer during registration and using a mobile application. In an embodiment, customer Glen may utilize client device 110 to rank the importance of these three characteristics.

The procedure continues to step 315 and the evaluation platform 120 receives a selection of one or more products. For example, and as described above, customer Glen may scan the QR code for blueberries from Lee's Farm, Tank's BB village, and Ken's BB Farm

The procedure continues to step 320 and the evaluation module 126 determines if each of the one or more selected products has a corresponding generated carbon value. For example, and as described above, blueberries from Lee's Farm and Tank's BB village have a corresponding carbon value that is generated according to the one or more embodiments as described herein. However, the blueberries from Ken's BB Farm do not have a corresponding carbon value that is generated according to the one or more embodiments as described herein.

The procedure continues to step 325 and the evaluation module 126 generates, for each of the one or more selected products that has a corresponding generated carbon value, a customer score based on the carbon value and one or more other values corresponding to other customer specific information. For example, and as described above, Glen prioritized wages paid over carbon footprint. Therefore, the evaluation module 126 generates a customer score for the blueberries from Lee's Farm that is higher than the generated score for the blueberries from Tank's BB Village.

The procedure continues to step 330 an the evaluation module 126 generates, for each of the one or more selected products that does not have a corresponding generated carbon value, a customer score without the generated carbon value and only the one or more values correspond to other specific information. For example, and as described above, Ken's BB farm does not have a corresponding generated carbon value. As such, the evaluation module 126 may generate a customer score for the blueberries farms as described above and based on only the other factors that include wages paid and vegetarian products. The procedure then ends at step 335.

Because the consumer can make informed purchasing decisions based on the customer score that is generated as described herein, the one or more embodiments as described herein provide an improvement in the field of electronic Green House Gas (GHG) measurement/management technology and/or electronic carbon measurement/management technology.

Specifically, the customer score that is generated according to the one or more embodiments as described herein may be based on any of a variety of different information (e.g., wages paid, carbon emitted/sequestered, etc.) regarding a product/ingredient at different points in time and along the entire lifecycle of the product/ingredient. That is, the one or more embodiments as described herein can obtain different information along the entire lifecycle of the product/ingredient such that the consumer has access to such information while, for example, the consumer is making a real-time (e.g., near real-time) purchasing decision at a store.

Based on the specific requirements and/or desires of the customer, the one or more embodiments as described herein can select particular information, aggregate the information, and/or manipulate (e.g., weighting algorithm) the information in real-time (e.g., near real-time) while the consumer is about to make a purchasing decision. Therefore, the customer score according to the one or more embodiments as described herein is dynamic and can be unique for each of a plurality of different consumers that, for example, may be simultaneously making purchasing decisions and have their own requirements/desires.

The one or more embodiments as described herein provide the flexibility and robustness to generate dynamic customer scores based on the variety of different factors along the entire lifecycle of a product/ingredient. As such, the one or more embodiments as described herein provide an improvement over conventional techniques that cannot generate a dynamic and/or real-time customer score for different customers based on the different factors as described herein. Since the generated score can be an accurate indicator regarding the affect that the creation, storage, and/or processing of the product/ingredient has on GHG emissions and/or carbon emissions/sequestration, the one or more embodiments as described herein provide an improvement in the existing technology of electronic GHG measurement/management technology and/or electronic carbon measurement/management technology.

Additionally, although the example considers the carbon footprint value, it is expressly contemplated that the one or more embodiments as described herein may include only the carbon emission value of carbon sequestration value. Further, any prioritization and/or weighting schema may be utilized to generate the customer score according to the one or more embodiments as described herein, and the different schemas may be selected by the evaluation platform 102 and/or the customer according to the one or more embodiments as described herein.

The foregoing description of embodiments is intended to provide illustration and description, but is not intended to be exhaustive or to limit the disclosure to the precise form disclosed. Modifications and variations are possible in light of the above teachings or may be acquired from a practice of the disclosure. For example, the particular formulas as utilized herein are for illustrative purposes only and it is expressly contemplated that the one or more embodiments as described herein can be used with different or no formulas. Moreover, while a series of acts has been described above, the order of the acts may be modified in other implementations. In addition, the acts, operations, and steps may be performed by additional or other modules or entities, which may be combined or separated to form other modules or entities. Further, non-dependent acts, operations, and steps may be performed in parallel. Also, the term “user”/“consumer”/“farmer”, as used herein, is intended to be broadly interpreted to include, for example, a computer or data processing system or a human user of a computer or data processing system, unless otherwise stated.

What is claimed is:

1. An evaluation platform, comprising:
a memory;
a processor coupled to the memory, the processor, when executing instructions stored in the memory, configured to:
obtain farm information describing one or more farm characteristics of a farm, wherein the farm includes at least a first field and a second field that are different fields of the farm, and wherein the first field produces a first product and the second field produces a second product;
obtain first field information describing one or more first field characteristics of the first field;
obtain second field information describing one or more second field characteristics of the second field;
obtain first product information describing one or more first product is characteristics of the first product;
obtain second product information describing one or more second product characteristics of the second product;
utilize, by a carbon algorithm, at least one of (1) the one or more farm characteristics, (2) the one or more first field characteristics, and (3) the one or more first product characteristics to determine a first carbon emission value for the first field;
utilize, by the carbon algorithm, at least one of (1) the one or more farm characteristics, (2) the one or more first field characteristics, and (3) the one or more first product characteristics to determine a first carbon sequestration value for the first field;
utilize, by the carbon algorithm, the first carbon emission value and the first carbon sequestration value to generate a first carbon footprint value for the first field, wherein the first carbon footprint value indicates the carbon impact for producing the first product at the first field;
utilize, by the carbon algorithm, at least one of (1) the one or more farm characteristics, (2) the one or more second field characteristics, and (3) the one or more second product characteristics to determine a second carbon emission value for the second field;
utilize, by the carbon algorithm, at least one of (1) the one or more farm characteristics, (2) the one or more second field characteristics, and (3) the one or more second product characteristics to determine a second carbon sequestration value for the second field;
utilize, by the carbon algorithm, the second carbon emission value and the second carbon sequestration value to generate a second carbon footprint value for the second field, wherein the second carbon footprint value indicates the carbon impact for producing the second product at the second field; and
suggesting, on a computer display, one or more actions that when implemented improve the first carbon footprint value for the first field or the second carbon footprint value for the second field.

2. The evaluation platform of claim 1, wherein the one or more farm characteristics include one or more of a location of the farm, climate information for the farm, farm management software utilized at the farm.

3. The evaluation platform of claim 1, wherein the one or more first field characteristics or the one or more second field characteristics include one or more of field management practice information, size of the field information, usage of field information, soil color of field information, soil texture of field information, number of trees or plants per acre information, year of planting information, land type information.

4. The evaluation platform of claim 1, wherein the one or more first product characteristics or the one or more second product characteristics include one or more of type information indicating a type of product and yield information indicating an amount of product produced.

5. The evaluation platform of claim 1, wherein the field is an area of land or a body of water.

6. The evaluation platform of claim 1, further comprising generating a carbon ledger for the product by aggregating the carbon footprint for the first field with one or more other carbon footprints associated with one or more other storage or processing facilities that store or process the first product after it leaves the first field.

7. The evaluation platform of claim 6, wherein the carbon ledger account for carbon emissions for transportation of the first product to the one or more other storage or processing facilities.

8. An evaluation platform, comprising:
a memory;
a processor coupled to the memory, the processor, when executing program instructions, configured to:
receive customer specific information that includes one or more factors of importance to a user when purchasing a product;
receive a selection of one or more products for sale at a merchant;
determine, for each product, if a generated carbon value exists; and
in response to determining that the generated carbon value exists for a particular selected product, utilizing an algorithm to generate a first customer score for the particular selected product, wherein the first customer score is based on the carbon value and one or more other values, for the selected product, that corresponds to the customer specific information, or
in response to determine that the corresponding generated carbon value does not exist for the particular selected product, utilizing the algorithm to generate a second customer score for the particular selected product, wherein the second customer scores does not consider carbon and is only based on the one or more other values, for the particular selected product, corresponding to the customer specific information.

9. The evaluation platform of claim 8, wherein the generated carbon value is a carbon footprint value that is generated for a first product that is produced on a farm of a field.

10. The evaluation platform of claim 9, wherein carbon footprint value is generated based on one or more field characteristics of the field, and the one or more field characteristics include one or more of field management practice information, size of the field information, usage of field information, soil color of field information, soil texture of field information, number of trees or plants per acre information, year of plantation information, land type information.

11. The evaluation platform of claim 10, wherein the carbon footprint value is generated based on one or more product characteristics of the first product, wherein one or more product characteristics include one or more of type information indicating a type of product and yield information indicating an amount of product produced.

12. The evaluation platform of claim 9, wherein the field is an area of land or a body of water.

13. The evaluation platform of claim 8, wherein receiving the selection of the one or more products is based on a quick response (QR) code associated with each of the one or more products.

14. A method, comprising:
obtaining, by a processor, farm information describing one or more farm characteristics of a farm, wherein the farm includes at least a first field and a second field that are different fields of the farm, and wherein the first field produces a first product and the second field produces a second product;
obtaining, by the processor, first field information describing one or more first field characteristics of the first field;
obtaining, by the processor, second field information describing one or more second field characteristics of the second field;
obtaining, by the processor, first product information describing one or more first ii product characteristics of the first product;
obtaining, by the processor, second product information describing one or more second product characteristics of the second product;
utilizing, by a carbon algorithm executed by the processor, (1) the one or more is farm characteristics, (2) the one or more first field characteristics, and (3) the one or more first product characteristics to determine a first carbon emission value for the first field;
utilizing, by the carbon algorithm executed by the processor, (1) the one or more farm characteristics, (2) the one or more first field characteristics, and (3) the one or more first product characteristics to determine a first carbon sequestration value for the first field;
utilizing, by the carbon algorithm executed by the processor, the first carbon emission value and the first carbon sequestration value to generate a first carbon footprint value for the first field, wherein the first carbon footprint value indicates the carbon impact for producing the first product at the first field;
utilizing, by the carbon algorithm executed by the processor, (1) the one or more farm characteristics, (2) the one or more second field characteristics, and (3) the one or more second product characteristics to determine a second carbon emission value for the second field;
utilizing, by the carbon algorithm executed by the processor, (1) the one or more farm characteristics, (2) the one or more second field characteristics, and (3) the one or more second product characteristics to determine a second carbon sequestration value for the second field; and
utilizing, by the carbon algorithm executed by the processor, the second carbon emission value and the second carbon sequestration value to generate a second carbon footprint value for the second field, wherein the second carbon footprint value indicates the carbon impact for producing the second product at the second field.

15. The method of claim 14, wherein the one or more farm characteristics include one or more of a location of the farm, climate information for the farm, farm management software utilized at the farm.

16. The method of claim 14, wherein the one or more first field characteristics or the one or more second field characteristics include one or more of field management practice information, size of the field information, usage of field information, soil color of field information, soil texture of field information, number of trees or plants per acre information, year of planting information, land type information.

17. The method of claim 14, wherein the one or more first product characteristics or the one or more second product characteristics include one or more of type information indicating a type of product and yield information indicating an amount of product produced.

18. The method of claim 14, wherein the field is an area of land or a body of water.

19. The method of claim 14, further comprising generating a carbon ledger for the product by aggregating the carbon footprint for the first field with one or more other carbon footprints associated with one or more other storage or processing facilities that store or process the first product after it leaves the first field.

20. The method of claim 19, wherein the carbon ledger account for carbon emissions for transportation of the first product to the one or more other storage or processing facilities.
